(19) United States
(12) Patent Application Publication
(10) Pub. No.: US 2024/0228337 A1
(43) Pub. Date: Jul. 11, 2024

(54) ATMOSPHERIC WATER GENERATOR HAVING STERILIZATION AND DISINFECTION FUNCTIONS

(71) Applicant: BIOTEK ENVIRONMENTAL SCIENCE LTD., NEW TAIPEI CITY (TW)

(72) Inventors: Ming-Yung HSU, NEW TAIPEI CITY (TW); Wei-Chun HSU, NEW TAIPEI CITY (TW)

(21) Appl. No.: 18/514,815

(22) Filed: Nov. 20, 2023

(30) Foreign Application Priority Data
Jan. 7, 2023 (TW) 112100700

(51) Int. Cl. C02F 1/461; C02F 1/467

(52) U.S. Cl. CPC C02F 1/46109; C02F 1/4672; C02F 2001/46142; C02F 2301/08; C02F 2303/04

(57) ABSTRACT

An atmospheric water generator having sterilization and disinfection functions includes a fan, a compressor, a condenser and an evaporator. The condenser is connected to the evaporator through an expansion valve. A water tray is disposed at a lower end of the evaporator. One end of the water tray has a nozzle. A water tank is disposed below the nozzle. A first electrolytic ozone water generator is provided in the water tank and located at a bottom of the water tank. One end of a water pipe is placed in the water tank. Another end of the water pipe is connected to a purified water outlet. A water pump and a screening program are provided on the water pipe in sequence. The atmospheric water generator has the advantages of simple structure, low cost, long service life, good sterilization and disinfection effect, environmental protection and safety.

### FIELD OF THE INVENTION

The present invention relates to an atmospheric water generator, and more particularly to an atmospheric water generator having sterilization and disinfection functions.

### BACKGROUND OF THE INVENTION

With the improvement of people's living standards, the demand for the quality of drinking water increases. The existing atmospheric water production technology blocks the way of pollution. The water generated by the atmospheric water generator is stored in a water tank. When the drinking water is required, the water flows out from the water tank. However, when the water is stored, it may cause secondary pollution due to the influence of the environment and external factors. Most of the existing sterilization technologies in the market are ultraviolet sterilization, which has a short lifespan and has dead spots for sterilization, resulting in incomplete sterilization. The sterilization effect is not good.

### SUMMARY OF THE INVENTION

In order to overcome the shortcoming of incomplete sterilization of the above-mentioned conventional ultraviolet sterilization equipment for drinking water, the primary object of the present invention is to provide an atmospheric water generator having sterilization and disinfection functions. The atmospheric water generator has the advantages of simple structure, low cost, long service life, complete sterilization without dead spots, good sterilization and disinfection effect, environmental protection and safety.

The technical solution provided by the present disclosure is as follows:

The atmospheric water generator having sterilization and disinfection functions comprises a fan, a compressor, a condenser and an evaporator. The compressor, the condenser and the evaporator are connected to one another. The condenser is connected to the evaporator through an expansion valve. A water tray is disposed at a lower end of the evaporator. One end of the water tray has a nozzle. A water tank is disposed below the nozzle. A first electrolytic ozone water generator is provided in the water tank and located at a bottom of the water tank. One end of a water pipe is placed in the water tank. Another end of the water pipe is connected to a purified water outlet. A water pump and a screening program are provided on the water pipe in sequence.

Preferably, in one embodiment of the present invention, the first electrolytic ozone water generator includes a first housing, first water inlets that are evenly arranged on two sides of the first housing, and a first water and air outlet formed on an upper end of the first housing. A first anode plate and a first cathode plate are disposed inside the first housing and connected to a first generator power cable. The first anode plate and the first cathode plate are spaced apart from each other. The first anode plate includes a titanium substrate and a tin dioxide coating layer doped with antimony. The first cathode plate is one of a titanium cathode plate and a stainless steel cathode plate.

Preferably, in one embodiment of the present invention, a second electrolytic ozone water generator is provided on the water pipe between the screening program and the purified water outlet.

Preferably, in one embodiment of the present invention, the second electrolytic ozone water generator includes a second housing, a second water inlet that is formed on one side of the second housing and connected to the water pipe, and a second water outlet that is formed on another side of the second housing and connected to the water pipe. A second anode plate and a second cathode plate are disposed inside the second housing and connected to a second generator power cable. The second anode plate and the second cathode plate are spaced apart from each other. The second anode plate includes a titanium substrate and a tin dioxide coating layer doped with antimony. The second cathode plate is one of a titanium cathode plate and a stainless steel cathode plate.

The beneficial effects of the present invention are described below: The atmospheric water generator is equipped with an electrolytic ozone water generator. The electrolytic ozone water generator has a very simple structure and low cost. The electrolytic ozone water generator may be directly installed in the water tank or/and the drinking water pipe. When the electrolytic ozone water generator is actuated, ozone microbubbles are generated. Ozone microbubbles are quickly dissolved and mixed into water to generate ozone water directly: Ozone water can sterilize the water in the water tank and the water pipe through which the ozone water flows to the water outlet. Besides, a small amount of ozone gas spreads into ambient air, forming an ozone gas environment around the water tank, which plays a bacteriostatic effect. The atmospheric water generator has a long service life and provides a complete sterilization without dead spots. The sterilization and disinfection effect is good. The generated ozone gas will never contain harmful gases such as nitrogen oxides, which is environmentally friendly and safe.

### BRIEF DESCRIPTION OF THE DRAWINGS

FIG. 1 is a structural schematic view of the present invention:

FIG. 2 is a structural schematic view of the first electrolytic ozone water generator of the present invention:

FIG. 3 is a schematic view illustrating the internal structure of the first electrolytic ozone water generator of the present invention; and

FIG. 4 is a schematic view illustrating the internal structure of the second electrolytic ozone water generator of the present invention.

### DETAILED DESCRIPTION OF THE PREFERRED EMBODIMENTS

Embodiments of the present invention will now be described, by way of example only, with reference to the accompanying drawings.

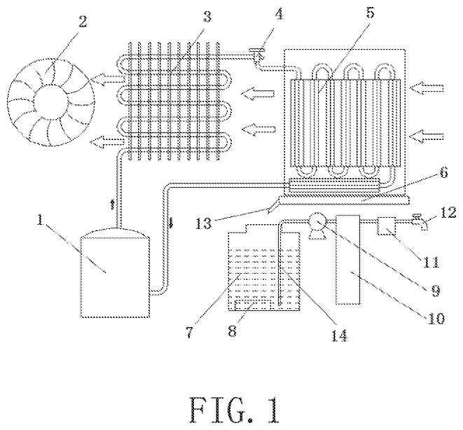

As shown in FIG. 1, an atmospheric water generator having sterilization and disinfection functions, comprising a compressor 1 and a fan 2. The refrigerant outlet of the compressor 1 is connected to a condenser 3. The air passing through an evaporator 5 is pushed by the fan 2 to pass through the condenser 3. The evaporator 5 is installed at the other side of the condenser 3. The condenser 3 is connected to the evaporator 5 through an expansion valve 4. The evaporator 5 is connected to the refrigerant inlet of the compressor 1. A water tray 6 is disposed at the lower end of the evaporator 5 for collecting water that is extracted from humid ambient air and condensed by the evaporator 5. One end of the water tray 6 has a nozzle 13. A water tank 7 is disposed below the nozzle 13. A first electrolytic ozone water generator 8 is provided in the water tank 7 and located at the bottom of the water tank 7. One end of a water pipe 14 is placed in the water tank 7, and the other end of the water pipe 14 is connected to a purified water outlet 12. A water pump 9 and a screening program 10 are provided on the water pipe 14 in sequence. A second electrolytic ozone water generator 11 is provided on the water pipe 14 between the screening program 10 and the purified water outlet 12.

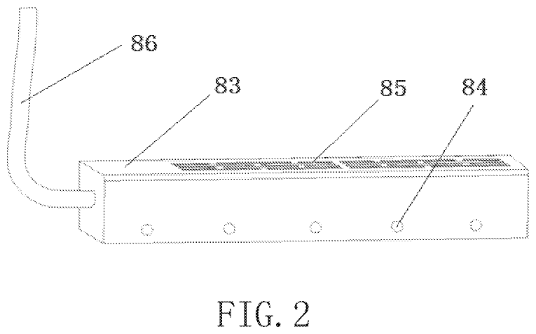

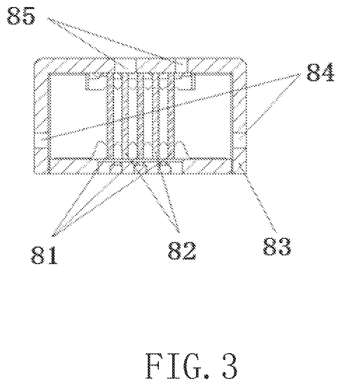

As shown in FIG. 2 and FIG. 3, the first electrolytic ozone water generator 8 includes a first housing 83, first water inlets 84 that are evenly arranged on both sides of the first housing 83, and a first water and air outlet 85 formed on an upper end of the first housing 83. A plurality of first anode plates 82 (two in this embodiment) and a plurality of first cathode plates 81 (three in this embodiment) are disposed inside the first housing 83 and connected to a first generator power cable 86. The first anode plates 82 and the first cathode plates 81 are spaced apart from each other. The first anode plates 82 are coated titanium anode plates. The coated titanium anode plates each include a titanium substrate and a tin dioxide coating layer doped with antimony. The first cathode plates 81 are titanium cathode plates or stainless steel cathode plates.

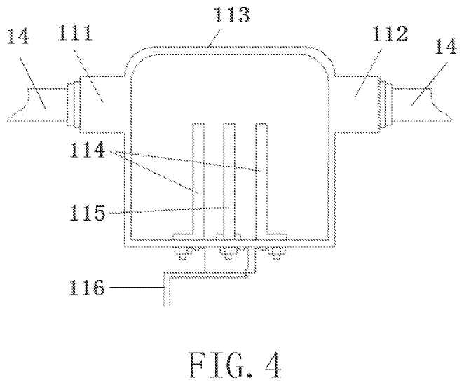

As shown in FIG. 4, the second electrolytic ozone water generator 11 includes a second housing 113, a second water inlet 111 that is formed on one side of the second housing 113 and connected to the water pipe 14, and a second water outlet 112 that is formed on the other side of the second housing 113 and connected to the water pipe 14. A second anode plate 115 and two second cathode plates 114 are disposed inside the second housing 113 and connected to a second generator power cable 116. The second anode plate 115 and the second cathode plates 114 are spaced apart from each other. The second anode plate 115 is a coated titanium anode plate. The coated titanium anode plate includes a titanium substrate and a tin dioxide coating layer doped with antimony. The second cathode plates 114 are titanium cathode plates or stainless steel cathode plates.

When the water level of the water tank 7 is lowered and water needs to be generated, the compressor 1 and the fan 2 are started. Under the action of the refrigerant, the surface of the evaporator 5 becomes cold, and the fan 2 makes the air flow through the surface of the evaporator 5 continuously. Moisture in the air condenses into water after passing through the evaporator 5, and water drops into the water tray 6. Then, the water flows from the nozzle 13 of the water tray 6 into the water tank 7 for storage. When the water in the water tank 7 needs to be disinfected and sterilized, the first electrolytic ozone water generator 8 is started. The water is electrolyzed under the action of an electric field. Hydrogen ions generate hydrogen gas at the first cathode plates 81. Oxygen ions generate ozone microbubbles under the catalyst action of the first anode plates 82. Ozone microbubbles are quickly dissolved and mixed into the water to generate ozone water directly. The water in the water tank 7 is circulated and exchanged into ozone water via the first water inlets 84 and the first water and air outlet 85 of the first housing 83, such that ozone water is distributed to the water tank 7 everywhere for sterilization and disinfection, without dead spots. Besides, a small amount of ozone gas spreads into ambient air, forming an ozone gas environment around the water tank, which plays a bacteriostatic effect.

When the water in the water pipe 14 needs to be disinfected and sterilized, the second electrolytic ozone water generator 11 is started. The water is electrolyzed under the action of an electric field. Hydrogen ions generate hydrogen gas at the second cathode plates 114. Oxygen ions generate ozone microbubbles under the catalyst action of the second anode plate 115. Ozone microbubbles are quickly dissolved and mixed into the water to generate ozone water directly. At this time, the water pump 9 is started, and the purified water outlet 12 is opened. The water in the water tank 7 flows to the second water inlet 111 of the second housing 113 after being purified by the screening program 10, and the generated ozone water passes through the second water outlet 112 to flow out via the purified water outlet 12. The ozone water plays a role of sterilization and disinfection on the water pipe flowing through. If the water is used normally, there is no need to start the second electrolytic ozone water generator 11, and the details will not be repeated here.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An atmospheric water generator having sterilization and disinfection functions, comprising a fan, a compressor, a condenser and an evaporator; the compressor, the condenser and the evaporator being connected to one another, the condenser being connected to the evaporator through an expansion valve; a water tray being disposed at a lower end of the evaporator, one end of the water tray having a nozzle, a water tank being disposed below the nozzle, a first electrolytic ozone water generator being provided in the water tank and located at a bottom of the water tank; one end of a water pipe being placed in the water tank, another end of the water pipe being connected to a purified water outlet, a water pump and a screening program being provided on the water pipe in sequence.

2. The atmospheric water generator as claimed in claim 1, wherein the first electrolytic ozone water generator includes a first housing, first water inlets that are evenly arranged on two sides of the first housing, and a first water and air outlet formed on an upper end of the first housing; a first anode plate and a first cathode plate are disposed inside the first housing and connected to a first generator power cable, and the first anode plate and the first cathode plate are spaced apart from each other.

3. The atmospheric water generator as claimed in claim 2, wherein the first anode plate includes a titanium substrate and a tin dioxide coating layer doped with antimony.

4. The atmospheric water generator as claimed in claim 2, wherein the first cathode plate is one of a titanium cathode plate and a stainless steel cathode plate.

5. The atmospheric water generator as claimed in claim 1, wherein a second electrolytic ozone water generator is provided on the water pipe between the screening program and the purified water outlet.

6. The atmospheric water generator as claimed in claim 5, wherein the second electrolytic ozone water generator includes a second housing, a second water inlet that is formed on one side of the second housing and connected to the water pipe, and a second water outlet that is formed on another side of the second housing and connected to the water pipe; a second anode plate and a second cathode plate are disposed inside the second housing and connected to a second generator power cable, and the second anode plate and the second cathode plate are spaced apart from each other.

7. The atmospheric water generator as claimed in claim 6, wherein the second anode plate includes a titanium substrate and a tin dioxide coating layer doped with antimony.

8. The atmospheric water generator as claimed in claim 6, wherein the second cathode plate is one of a titanium cathode plate and a stainless steel cathode plate.
